(19) United States
(12) Patent Application Publication
(10) Pub. No.: US 2015/0033909 A1
(43) Pub. Date: Feb. 5, 2015

(54) AXLE ASSEMBLY

(71) Applicant: AMERICAN AXLE & MANUFACTURING, INC., Detroit, MI (US)

(72) Inventor: Rodney J. Campbell, Grand Blanc, MI (US)

(73) Assignee: AMERICAN AXLE & MANUFACTURING, INC., Detroit, MI (US)

(21) Appl. No.: 14/372,536

(22) PCT Filed: Nov. 12, 2013
(86) PCT No.: PCT/US2013/068482

§ 371 Date: Jul. 16, 2014

Related U.S. Application Data
(60) Provisional application No. 61/722,860, filed on Nov. 6, 2012.

(51) Int. Cl. B60B 35/12; F16H 48/06

(52) U.S. Cl. CPC B60B 35/121; F16H 48/06
USPC 74/607

(57) ABSTRACT

An axle assembly having a tube, a shaft received in the tube, a wheel bearing disposed between the tube and the shaft. The axle assembly also includes a thrust washer, a retaining ring and a snap ring, each of which is mounted about the shaft. The wheel bearing supports the shaft for rotation in the tube. The thrust washer abuts both a shoulder on the shaft and an inner bearing race of the wheel bearing. The retaining ring abuts the inner bearing race such that the wheel bearing is disposed between the thrust washer and the retaining ring. The snap ring abuts the retaining ring and limits movement of the retaining ring in a direction away from the wheel bearing.

### CROSS-REFERENCE TO RELATED APPLICATIONS

This application claims priority to U.S. Provisional Patent Application No. 61/722,860 filed Nov. 6, 2012, the disclosure of which is incorporated by reference as if fully set forth in detail herein.

### FIELD

The present disclosure relates to an axle assembly.

### BACKGROUND

This section provides background information related to the present disclosure which is not necessarily prior art.

U.S. Pat. No. 7,984,782 discloses an axle assembly having a retainer plate that is removably coupled to an axle tube of an axle housing assembly. The retainer plate may be removed from the axle tube to permit an axle shaft to be withdrawn from a differential assembly.

### SUMMARY

This section provides a general summary of the disclosure, and is not a comprehensive disclosure of its full scope or all of its features.

In one form, the present teachings provide an axle assembly having an axle housing assembly, an axle shaft, a wheel bearing, a thrust washer, a retainer and a snap ring. The axle housing assembly has an axle tube into which the axle shaft is received. The wheel bearing is disposed between the axle tube and the axle shaft, and supports the axle shaft for rotation in the axle tube. The thrust washer is mounted on the axle shaft. The thrust washer abuts a shoulder on the axle shaft and an inner bearing race of the wheel bearing. The retainer is mounted about the axle shaft and abuts the inner bearing race such that the wheel bearing is disposed between the thrust washer and the retainer.

The snap ring is mounted on the axle shaft and abuts the retainer to limit movement of the retainer in a direction away from the wheel bearing.

In another form, the present teachings provide a method for servicing an axle assembly. The method includes: removing a retainer from an axle tube; withdrawing a shaft member from the axle tube to access a retaining ring that is mounted to a retainer portion on the shaft member; withdrawing the retaining ring from the shaft member to access a wheel bearing; and withdrawing the wheel bearing from the shaft member.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a vehicle having an axle assembly constructed in accordance with the teachings of the present disclosure;

FIG. 2 is a partially broken-away perspective view of a portion of the vehicle of FIG. 1 illustrating the axle assembly in more detail;

FIG. 3 is section view of a portion of the axle assembly of FIG. 1 taken longitudinally through a distal end of a tube assembly.

Corresponding reference numerals indicate corresponding parts throughout the several views of the drawings.

### DETAILED DESCRIPTION

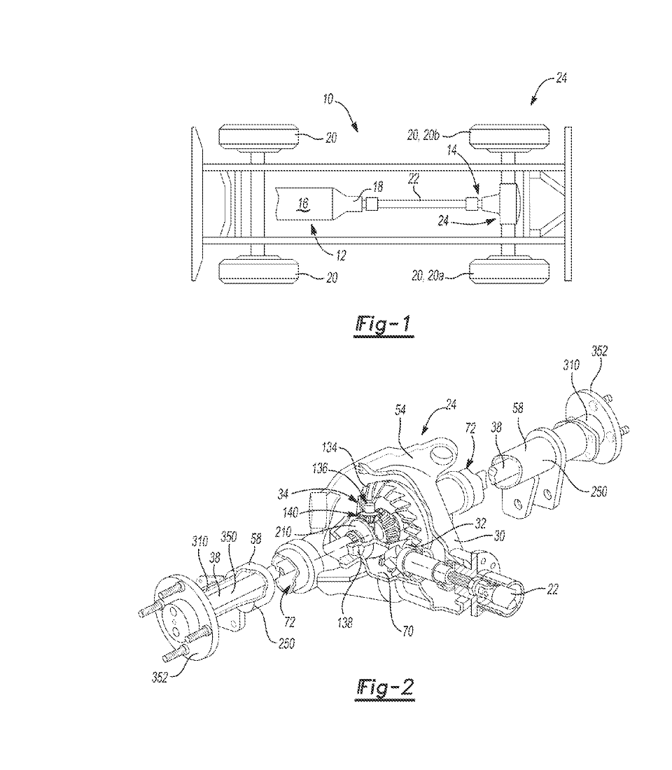

With reference to FIG. 1 of the drawings, an exemplary vehicle 10 is schematically illustrated as having an axle assembly (i.e., rear axle assembly 24 in the particular example provided) that is constructed in accordance with the teachings of the present disclosure. The vehicle 10 can include a power train 12 and a drive train 14. The power train 12 can comprise any means for generating propulsive power, such as an internal combustion engine 16 and/or an electric motor (not shown), and a conventional transmission 18. The transmission 18 can receive rotary power from the propulsive power generating means (e.g., indirectly, through a conventional clutch and/or torque converter) and can perform a speed reduction/torque multiplication function before outputting the propulsive power to the drive train 14.

The drive train 14 can be configured in any desired manner to transmit propulsive power received from the transmission 18 to one or more sets of the vehicle wheels 20. In this regard, those of skill in the art will appreciate that the drive train 14 can have a two-wheel drive configuration or a type of four or all-wheel drive configuration (e.g., full-time four wheel drive, part-time four wheel drive). In the particular example provided, the drive train 14 has a rear-wheel drive configuration and includes a propshaft 22 and a rear axle assembly 24. Rotary power output from the transmission 18 can be received by the propshaft 22 and transmitted to the rear axle assembly 24, where it can be selectively apportioned in a predetermined manner to the left and right rear wheels 20a and 20b, respectively.

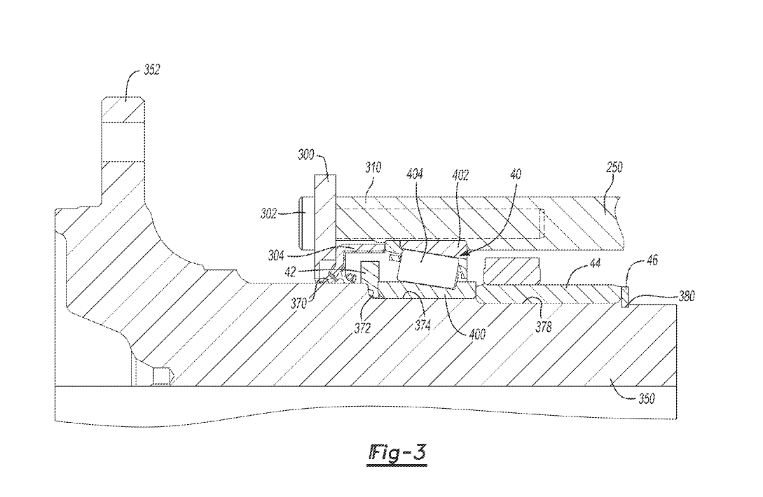

With reference to FIGS. 2 and 3, the rear axle assembly 24 can include an axle housing assembly 30, an input pinion 32, a differential assembly 34, a pair of axle shafts 38, a pair of wheel bearings 40 (FIG. 3—only one is specifically shown), a pair of thrust washers 42 (FIG. 3—only one is specifically shown), a pair of retainer rings 44 (FIG. 3—only one is specifically shown), and a pair of snap rings 46 (FIG. 3—only one is specifically shown). The axle housing assembly 30 can include a carrier housing 54 and a pair of axle tube assemblies 58. The carrier housing 54 can define a differential cavity 70 and a pair of axle tube apertures 72. Each of the axle tube apertures 72 is configured to receive a corresponding one of the axle tube assemblies 58. The input pinion 32 can be rotatably supported by the carrier housing 54 and coupled for rotation with the propshaft 22. The differential assembly 34 can be rotatably disposed in the differential cavity 70 and can comprise a ring gear 134, which can be meshingly engaged to the input pinion 32, and a differential 136 having a pair of output members 210 (only one of which is specifically shown). In the particular example provided, the differential 136 includes a differential case 138, which is coupled to the ring gear 134 for rotation therewith, and a differential gearset 140 in which the output members 210 comprise side gears.

Each axle tube assembly 58 can include an axle tube 250, a retainer 300, a plurality of threaded fasteners 302 (only one is specifically shown) and a seal 304. Each axle tube 250 can be received into a corresponding one of the axle tube apertures 72 and can be fixedly coupled to the carrier housing 54. In the particular example provided, each axle tube aperture 72 is configured to receive a proximal end of a corresponding one of the axle tubes 250 in an interference fit manner. Slug welds can be employed to inhibit axial and rotational movement of the axle tubes 250 within the axle tube apertures 72. The seal 304 can be received into and sealingly engaged to a distal end 310 of the axle tube 250. The retainer 300 can be a plate-like structure that can be removably coupled to the distal end 310 of the axle tube 250. If desired, components of a brake system, such as a back-plate (not shown) of a drum brake system or a brake caliper mount (not shown) of a disc brake system can be fixedly coupled to the distal end 310 of the axle tube 250.

Each axle shaft 38 can comprise a shaft member 350, which can be drivingly engaged to a corresponding one of the output members 210, and a wheel flange 352 that is fixed to an end of the shaft member 350 on a side opposite the output member 210. The shaft member 350 can include a seal surface 370, a shoulder 372, a bearing surface 374, a retainer portion 378 and a ring groove 380. The seal surface 370 can be a circumferentially extending surface to which a seal element on a corresponding one of the seals 304 can be sealingly engaged. The wheel flange 352 can be configured to be mounted to an associated one of the wheels 20a, 20b (FIG. 1).

The wheel bearings 40 can be tapered roller bearings with an inner bearing race 400, which can be press-fit onto the bearing surface 374 on an associated one of the axle shafts 38, an outer bearing race 402, which can be press-fit to the inside diameter of a counterbore formed in the distal end 310 of an associated one of the axle tubes 250, and a plurality of bearing elements 404 that can be received between the inner and outer bearing races 400 and 402. The wheel bearings 40 can rotatably support the axle shafts 38 on the axle tubes 250. In this regard, the wheel bearings 40 support the axle shafts 38 for rotation in the axle tubes 250.

Each thrust washer 42 can be received on a corresponding shaft member 350 axially outwardly of the wheel bearing 40 and can be abutted against the shoulder 372 such that the seal 304 is disposed axially between the thrust washer 42 and the outer bearing race 402 of the wheel bearing 40. The thrust washer 42 can be sized to limit outward axial movement of the shaft member 350 relative to the axle tube 250. Each retainer ring 44 can be received on the retainer portion 378 of a corresponding shaft member 350 such that the wheel bearing 40 is disposed between the retainer ring 44 and the thrust washer 42. In the particular example provided, the outside diameter of the retainer portion 378 is smaller than the outside diameter of the bearing surface 374, but it will be appreciated that the bearing surface 374 and the retainer portion 378 may be sized differently if desired. Each of the snap rings 46 can be received into the ring groove 380 in a corresponding one of the shaft members 350 to axially fix the snap ring 46 to the shaft member 350 on a side of the retainer ring 44 opposite the wheel bearing 40 (i.e., so that the retainer ring 44 is disposed between the wheel bearing 40 and the snap ring 46). It will be appreciated that the snap ring 46 can limit movement of the retainer ring 44 in an axial direction away from the (adjacent) wheel bearing 40.

It will be appreciated that the thrust washer 42 and the retainer ring 44 can be employed to position the inner bearing race 400 relative to the outer bearing race 402 to thereby control the preloading of the wheel bearing 40.

In the event that the seal 304 or the wheel bearings 40 need servicing (e.g., replacement), the retainer 300 must be removed from the distal end 310 of the axle tube 250 (e.g., by removing the threaded fasteners 302 that releasably secure the retainer 300 to the axle tube 250) and the shaft member 350 (with the inner bearing race 400 attached thereto) can be withdrawn from the axle tube 250. If the retainer 300 is not first removed from the axle tube 250, interference between the thrust washer 42, the seal 304 and the retainer 300 will prevent the shaft member 350 from being withdrawn from the axle tube 250.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

1. An axle assembly comprising:
an axle housing assembly having an axle tube;
a differential assembly received in the axle housing assembly, the differential assembly comprising a differential case, a pair of output members, which are housed in the differential case, and a ring gear that is coupled to the differential case for rotation therewith;
an input pinion supported for rotation in the axle housing assembly and meshingly engaged to the ring gear;
an axle shaft received in the axle tube, the axle shaft being drivingly engaged with one of the output members;
a wheel bearing disposed between the axle tube and the axle shaft, the wheel bearing supporting the axle shaft for rotation in the axle tube;
a thrust washer mounted on the axle shaft, the thrust washer abutting a shoulder on the axle shaft and an inner bearing race of the wheel bearing;
a retaining ring mounted about the axle shaft and abutting the inner bearing race such that the wheel bearing is disposed between the thrust washer and the retaining ring; and
a snap ring mounted on the axle shaft, the snap ring abutting the retaining ring and limiting movement of the retaining ring in a direction away from the wheel bearing.

2. The axle assembly of claim 1, wherein a seal is disposed on a side of the wheel bearing opposite the retaining ring.

3. The axle assembly of claim 2, wherein a retainer abuts the seal on a side of the seal opposite the wheel bearing such that the seal is received axially between the thrust washer and the wheel bearing.

4. The axle assembly of claim 3, wherein the seal sealingly engages a seal surface formed on the axle shaft.

5. The axle assembly of claim 3, wherein a plurality of threaded fasteners secure the retainer to the axle tube.

6. The axle assembly of claim 1, wherein the inner bearing race is mounted on a bearing surface having a first diameter, wherein the retaining ring is mounted on a retainer portion having a second diameter, and wherein the second diameter is smaller than the first diameter.

7. The axle assembly of claim 1, wherein the wheel bearing comprises an outer bearing race that is received into a counterbore formed in the axle tube.

8. A method for servicing an axle assembly comprising:
removing a retainer from an axle tube;
withdrawing a shaft member from the axle tube) to access a retaining ring that is mounted to a retainer portion on the shaft member;
withdrawing the retaining ring from the shaft member to access a wheel bearing; and
withdrawing the wheel bearing from the shaft member.

9. The method of claim 8, wherein withdrawal of the wheel bearing from the shaft member provides access to a thrust washer and wherein the method further comprises withdrawing the thrust washer from the shaft member.

10. The method of claim 9, wherein withdrawal of the thrust washer from the shaft member provides access to a seal and wherein the method further comprises withdrawing the seal from the shaft member.
